(19) United States
(12) Patent Application Publication
(10) Pub. No.: US 2006/0235562 A1
(43) Pub. Date: Oct. 19, 2006

(54) Method and system for manufacturing a three-dimensional object

(75) Inventors: German Enrique Knoppers, Rotterdam (NL); Walter Adrianus Gerardus Kleyweg, Berkel en Rodenrijs (NL); Jeroen van den Hout, Leiden (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Nederlandse Organisatie voor toegepast-natuurwetenschappelijk Onderzoek TNO, Delft (NL)

(21) Appl. No.: 10/490,814

(22) PCT Filed: Sep. 26, 2002
(86) PCT No.: PCT/NL02/00618

§ 371 Date: Sep. 6, 2005

(30) Foreign Application Priority Data
Sep. 26, 2001 (NL) 1019045

(51) Int. Cl. G06F 19/00

(52) U.S. Cl. 700/119

(57) ABSTRACT

A three-dimensional object is automatically manufactured by making a surface model of the object; making a voxel model of the object, with a lower resolution than the surface model, the voxel model, place-dependently per voxel, containing information about a composition of the material of which the object must be made at the place of the voxel; forming the object by pointwise depositing material, the composition of the deposited materiel per point being controlled with the voxel model, and the deposition or non-deposition of the material on different sides of the surface being controlled with the surface model with higher resolution than the control of the composition.

The invention relates to the automatic manufacture of a three-dimensional object, in particular a prototype, under control of a computer model of the object.

Techniques for automatically making a three-dimensional prototype of an object on the basis of a computer model of the object are known from, inter alia, U.S. Pat. No. 5,768,134. These techniques are particularly used for obtaining a spatial impression, for instance of a body part in preparation of a medical operation, or of an intended manufacturing product during the development of that product.

Surface models and volume models are started from herein. An example of a surface model describes, for instance, the coordinates of the angular points of a system of triangles that form the surface. A volume model starts from the space being divided into a three-dimensional raster of volume elements (voxels) and provides a set of parameters each describing whether a specific voxel lies inside or outside the object and, if it lies inside the object, what, for instance, the color of the material in the voxel is.

The above-mentioned US patent obtains a volume model by means of a scanner and converts that volume model into a surface model used for the manufacture of the object.

It would be desirable to also make use products in this -way, that is to say objects not only used for representing the appearance of a product, but which also have a number of the material properties of the product. This is particularly not simple if the object consists of different materials in different places, or if even gradients in material composition occur.

However, different manufacturing techniques that render this possible are already known, such as “Direct Laser Powder Deposition” (DLPD) techniques LENS (Optomec), DMD (POM), CMB (Röders) etc. An example of such a technique is the use of a number of nozzles, each for another material (for instance a plastic, a metal etc.). Under control of a computer, the respective material in powdered form is or is not sprayed from the different nozzles, melted during flight, so that the material from the different nozzles together drops down at a point on the object and solidifies.

By doing this at a series of points, the object can be built up point by point, and by using different ratios of materials for the different points, a place-dependent material composition can berealized.

However, a technique for automatically controlling this process accurately under control of a computer model is not known as yet.

It is, inter alia, an object of the invention to provide an accurate method and system for carrying out such a method, to automatically manufacture, under control of a computer model, a three-dimensional object of which the material composition is internally place-dependent.

The invention provides a method for automatically manufacturing a three-dimensional object, which comprises the steps of
supplying first data that forms a surface model of the object;
supplying second data that forms a voxel model of the object, with a lower resolution than the surface model, the second data, place-dependently per voxel, containing information about a composition of the material of which the object must be made at the place of the voxel;
forming the object by pointwise depositing the material, the composition of the deposited material per point being controlled with the second data, and the deposition or non-deposition of the material on different sides of the surface being controlled with the first data with higher resolution than the control of the composition.

The surface model is preferably a parametric model, for instance a triangular model.

Thus it is possible to control the composition of the object place-dependently without needing an extremely large memory. If one wished to realize a similar surface resolution with only a volume model, then an excessive amount of data would be necessary. If, for instance, a resolution of 0.01 mm is desired for an object 100 mm in size, 10¹² voxels would be necessary in that case. According to the invention, much fewer voxels are necessary, because it does not prove necessary to control the composition with the same resolution as the form of the surface.

These and other objectives and advantageous aspects of the method and the system according to the invention will be specified with reference to the following figures.

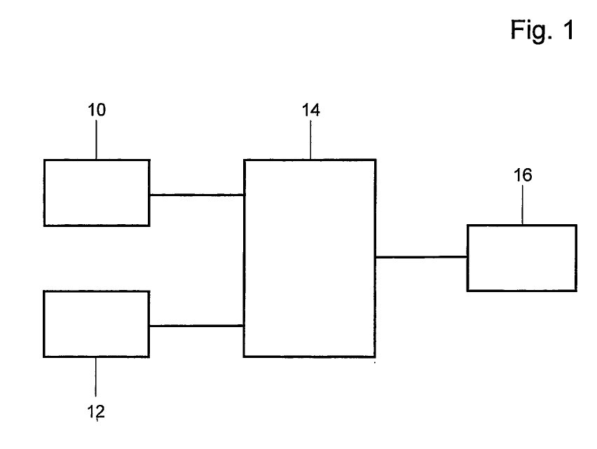

FIG. 1 shows a system for controlling a manufacturing process;

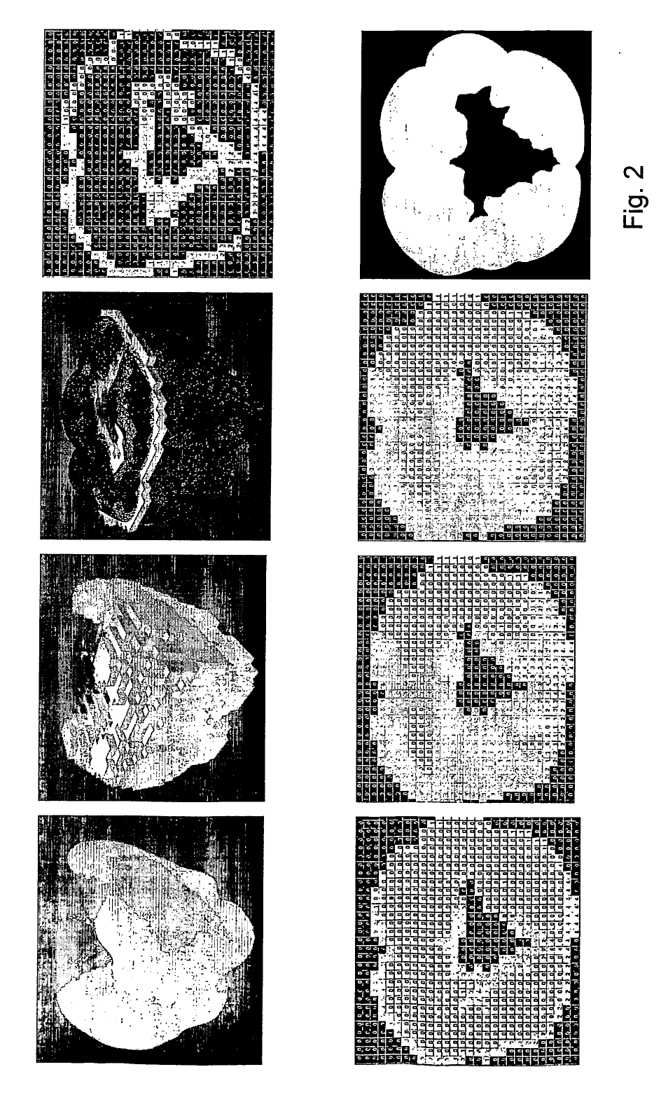

FIG. 2 illustrates a number of steps in the generation of a volume model;

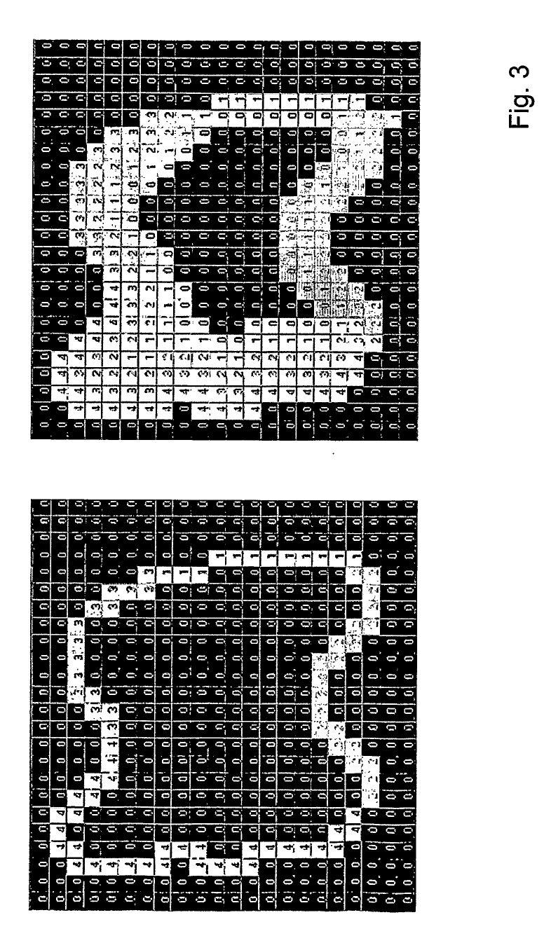

FIG. 3 shows a representation of a volume model;

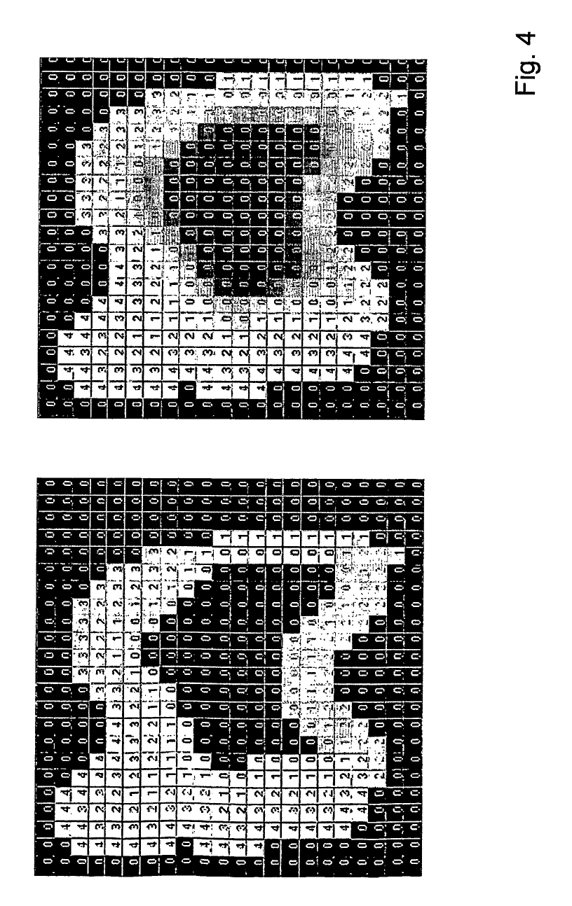

FIG. 4 shows a further representation of a volume model.

FIG. 1 shows a system for controlling a manufacturing process. The system contains a memory 10 for a surface model, a memory 12 for a volume model (without departing from the invention both memories 10, 12 may be parts of a single memory), a control computer 14 and a material depositing unit 16.

For the material depositing unit 16, any unit may be used that is capable of building up a three-dimensional object point by point (with, for instance, spherical points having a diameter of 0.02 mm or 0.1 mm), the material composition being able to change from point to point. Such units are already known. They use, for instance, “Direct Laser Powder Deposition” (DLPD) techniques LENS (Optomec), DMD (POM), CMB (Röders) etc.

In operation, data representing a surface of the object (e.g. the outside surface and possible internal surfaces, or separating surfaces between different parts of the object) is stored in the memory 10 for the surface model. For this, for instance, an STL model (STL=Standard Triangle Language) is used, which contains the coordinates of the angular points of a system of triangles describing the surface. But other models, such as NURBS, Bezier shapes etc., can also be used, which describe curved surfaces with parameters of a mathematical equation describing the surface. Therefore, the surface is not described with points, but with parameters giving a continuous description of the surface.

In the memory 12 for the volume model, data is stored. The volume model starts from a division of the space into a number of voxels, and for each voxel the model contains one or more parameters indicating whether the voxel lies inside the object and what the composition of the material in the voxel must be. The division of the space is preferably such that each voxel describes a much larger partial volume of the space than a single point that can be provided by the material depositing unit 16. There is typically an order of magnitude difference in the diameters of the voxels and the points, for instance a factor greater than two or greater than ten. Thus even for rather large objects a relatively limited number of voxels will suffice. In order to further save on the required information, use may also be made of an octree structure in which for groups of voxels with homogeneous parameter values this parameter value is each time stored only once. Also, use may be made of a lookup table (LUT) in the memory 12 with entries in which possible parameter values are stored, the volume model data per voxel or homogeneous group of voxels then being sent to an entry in the LUT.

According to the invention the volume model for each voxel contains one or more parameters specifying the material composition of the object. In one embodiment these parameters specif1y the composition homogenously for the whole voxel, in terms of the components of the composition and/or the relative concentrations of the components. In a further embodiment the parameters, for instance, also specify a gradient of the concentrations (derivative to the place) or possibly also higher derivatives. In all cases the number of parameters used for the specification is, however, much smaller than would be necessary for specifying the composition of each point inside the voxel separately.

The control computer 14 controls the material depositing unit 16 such that a three-dimensional object is built up point by point. The control computer 14 then uses surface model information from the memory 10 for the surface model for each point to control the material depositing unit 16 which at that point must or must not deposit material. To that end, the control computer 14 determines whether the position of the respective point lies inside or outside the surface of the object specified by the surface model and orders deposition of the material only if the point lies inside the surface.

The control computer 14 uses volume model information from the memory 12 for the volume model to control the material composition of the different points. In general, one voxel corresponds to several (a large number of) different points at which the material depositing unit 16 can deposit material of different composition. The control computer 14 calculates within which voxel the respective point is, reads the parameter describing the material properties of that voxel from the memory 12 for the volume model and controls the material depositing unit to deposit the material composedly at the point according to that parameter. In the case of a homogeneous description for the composition of the voxel, the composition as specified for the whole voxel is deposited at the point. In the case of a gradient specification the control computer calculates the composition at the place of the voxel and controls the material depositing unit with the calculated value.

In practice, the control computer 14 realizes this by working with successive cross-sections of the object to be manufactured, each having the thickness of the points provided by the material depositing unit 16. For each cross-section, the control computer 14, with the above-described technique of edge determination, with the surface model and composition determination with the volume model, calculates a two-dimensional image with pixels describing the composition of the material to be deposited, on a pixel resolution corresponding to that of the points to be deposited. The control computer 14 sends this image to the material depositing unit which, on the basis of each pixel, provides a respectivte point of the material. The memory for this image can then be reused again before the formation of the whole object. Thus an excessive amount of memory is not necessary. As an alternative, the control computer 14 may of course also calculate the information point by point and transmit each time only control information for a part of the points in a cross-section, or even for a single point before the material depositing unit 16 provides the material.

In the manner described, the adjustment of the surface form will take place with a greater spatial resolution than the distribution of the material over the volume of the object. But this saves an excessive amount of memory 12 for the volume model. It has turned out, however, that in most applications a lower resolution for the material composition will suffice. It is often essential that the composition changes, but less essential how the composition changes as a function of the place. In the case of a finger-like core of copper in a mainly steel mold, for instance (to improve the heat conduction), an accurate material distribution is not necessary. The described technique is therefore very suitable for making such molds.

Preferably, the data of the volume model is generated from the data of the surface model. This makes it simpler and more convenient to design the volume model.

FIG. 2 illustrates a number of steps in a computer algorithm in which a surface model (e.g. an STL model) is converted into a volume model with information about gradients in material composition. For this a computer program is preferably used that can run on control computer 14, but also on another computer, after which the generated volume model is then loaded into the memory 12.

In a first step of the algorithm a surface model is started from. An object described by this model is shown as step 1, with gray tint differences between places where a different material composition is necessary.

Subsequently, parameters are filled in for a number of voxels indicating whether the voxels lie inside the object. It is calculated which voxels are crossed by the surface. The parameters describing the material composition of voxels crossed by the surface are also filled in. These are, for instance, derived from a model indicating the composition of the surface. This can be done, for instance, by giving a composition parameter per surface element from the surface model, but by other techniques, such as specification of a place-dependent composition function of the surface, computer graphics-like texture mapping of composition parameters on surface coordinates etc.

This step may, if desired, be repeated a number of times to assign parameters about different material properties to the voxels that are crossed by the surface. The object described by the resulting voxel model is represented in the part “step 2” of the figure.

Step 3 and step 4 indicate a cross-section of the model. In step 4 is shown a layer of voxels from the cross-section indicated in step 3. The voxels that are crossed by the surface are indicated with a different gray tint.

Subsequently, a growth treatment is carried out, in which each time parameters of voxels are calculated on the basis of parameters of spatially neighboring voxels. Step 5 schematically shows an intermediate result of the growth treatment and step 6 the final result, with different parameter values indicated with different gray tints.

If desired, a smoothing of the spatial variation of the parameter values is carried out, the result of which is illustrated in “step 7”. This is the end point of the generation of the volume model, which is then used by the control computer 14 to control the material depositing unit 16. The volume model is preferably generated as a whole (that is to say in three dimensions and not isolated in a layer), with the growth treatment also comprising a growth from the edge voxels in three dimensions.

If desired, generation may take place layfer by layer with two-dimensional growth (layers as shown in steps 4-8), with the control computer each time after generation of a layer of the volume model controlling the material depositing unit 16 to deposit the respective layer with the calculated composition.

“Step 8” illustrates the effect of the manner in which the control computer 14 controls the material depositing unit 16 to deposit a layer, that is to say with composition data determined from the volume model (step 7) and surface delimitation from the surface model.

The growth treatment (step 5 and step 6) may be carried out in different manners depending on the desired spatial material distribution.

FIG. 3 shows the effect of a first manner of carrying out the growth treatment. Here a weight factor with a fixed value is assigned to the voxels lying on the edge. Subsequently, in each voxel for which the weight factor has not yet been assigned, but which adjoins a voxel for which this is the case, the maximum value of the weight factor for the neighboring voxels is determined. If this value is below a threshold value, then a weight factor of zero is assigned to the voxel and a default composition. Otherwise a fraction of this maximum weight factor is assigned to the voxel as weight factor, together with the composition parameters of the neighboring voxel that possessed the maximum weight factor.

Of course, this is not the only possible technique: instead of taking over the composition parameters from the voxel with the maximum weight factor, the composition parameter can be calculated by weighing composition parameters of the neighboring voxels. The weight factor can also be determined otherwise, for instance through reduction by a fixed amount of the maximum weight factor of the neighbors.

All these growth techniques can be used both three-dimensionally (neighbors in 3 coordinate directions) and two-dimensionally or even one-dimensionally.

It will be clear that the invention is not Lmited to the stated growth treatments, other techniques known from the image treatment literature may also be used. Preferably, the user can determine which technique is used, so as to obtain a desired effect.

FIG. 4 further shows a technique of fading, in which the spatial distribution of the parameter values is filtered layer by layer.

In a comparable manner, per voxel a gradient or more higher order derivative of the composition parameters can be determined. For this a finite element model or something similar may also be used to calculate the composition parameters and/or derivatives thereof by solving a differential equation from the composition parameters of the surface.

The described method for generating the three-dimensional model may, as described, be used for forming an outside surface of the manufactured object. The surface model may, however, also describe internal surfaces that form the boundary between different materials from which the object is built up. In that case, the described method can be used several times, each time for a different part of the object on one side of such a boundary. After this, the material is provided at points in the parts on the different sides of the boundary, each as calculated when carrying out the method for the respective part.

1. A method of automatically manufacturing a three-dimensional object, which comprises the steps of:
supplying first data comprising a surface model of the object;
supplying second data compising a volume model of the object,
wherein the second data specifies, with a lower resolution than the surface model and place-dependently per voxel, information about a composition of denosited material making up a part of the object at the place of a voxel; and
forming the object by pointwise depositing material, wherein the composition of deposited material points specified by the second data, and the deposition or non-deposition of the material on different sides of the surface of the object is specified by the first data with higher resolution than the second data specifying the composition of deposited material.

2. A method according to claim 1, wherein the second data is automatically generated from the first data by performing the steps of:
assigning composition parameters to surfaces from the surface model;
determining voxels of the volume model that are crossed by the surfaces specified by the surface model of the object;
assigning composition parameters of the surfaces to voxels of the volume model that are crossed by the surfaces;
assigning further composition parameters to other voxels of the volume model by calculating from composition parameters.

3. A system for manufacturing an object according to the method of claim 1 including:
a first and second memory for respectively the first and second data;
a material depositing unit;
a control computer coupled to the memories and the material depositing unit for controlling the material depositing unit depending on the first and second data.

4. A computer program product in a computer readable medium provided with a computer program for controlling a method according to claim 1.

5. A computer program product in a computer readable medium provided with a computer program for performing the steps of:
receiving first data comprising a surface model of an object;
generating second data comprising a volume model of the object,
wherein the second data specifies, with a lower resolution than the surface model, and place-dependently per voxel, information about a composition of deposited material making up a part of the object at the place of a voxel; in which the second data is automatically generated from the first data by
assigning composition parameters to surfaces from the surface model;
determining voxels from the volume model that are crossed by the surfaces;
assigning composition parameters of the surfaces to the voxels that are crossed by the surfaces;
assigning further composition parameters of other voxels by calculating from composition parameters or further composition parameters of neighboring voxels of the respective other voxels.

6. A method according to claim 1, wherein the second data is automatically generated from the first data by performing the steps of:
assigning composition parameters to surfaces from the surface model;
determining voxels of the volume model that are crossed by the surfaces specified by the surface model of the object;
assigning composition parameters of the surfaces to voxels that are crossed by the surfaces;
assigning further composition parameters to other voxels of the volume model from composition parameters of neighboring voxels of the respective other voxels.

7. A system for manufacturing an object according to the method of claim 6 including:
a first and second memory for respectively the firt and second data;
a material depositing unit;
a control computer coupled to the memories and the material depositing unit for controlling the material depositing unit depending on the first and second data.

8. A computer program product in a computer readable medium provided with a computer program for controlling a method according to claim 6.

9. A system for manufactring an object according to the method of claim 2 including:
a first and second memory for respectively the first and second data;
a material depositing unit;
a control computer coupled to the memories and the material depositing unit for controlling the material depositing unit depending on the first and second data.

10. A computer program product in a computer readable medium provided with a computer program for controlling a method according to claim 2.
